(19) United States
(12) Patent Application Publication
(10) Pub. No.: US 2026/0275770 A1
(43) Pub. Date: Sep. 17, 2026

(54) Smart Lock Assembly with Solar Cell

(71) Applicant: Last Lock Inc., Madison, WI (US)

(72) Inventors: Alexander Mahnke, Madison, WI (US); Adam Johnson, Madison, WI (US)

(21) Appl. No.: 19/564,110

(22) Filed: Mar. 11, 2026

Related U.S. Application Data
(60) Provisional application No. 63/769,815, filed on Mar. 11, 2025.

(51) Int. Cl. E05B 63/08; E05B 47/00

(52) U.S. Cl. CPC E05B 63/08; E05B 2047/0056; E05B 2047/0064

(57) ABSTRACT

The present disclosure relates to a smart lock assembly. A solar cell layer is presented which generates power for the smart lock. The smart lock assembly has a transparent cover over the solar cell. The smart lock assembly has a circuit board connected to the solar cell. The smart lock assembly includes a time-of-flight sensor that is mounted to the circuit board and emits and detects signals for user detection. A cutout in a conductive layer of the solar cell allows a signal from the time-of-flight sensor to penetrate the solar cell without significantly degrading the signal while being emitted or returned. The solar cell absorbs light while permitting the time-of-flight sensor's signal to pass through.

### FIELD

The present disclosure is directed to a lock system, specifically an electronic lock system. It also relates to radio-frequency identification (RFID) processing for smart locks and access readers and various signal processing techniques. The present application claims priority to U.S. Provisional Application No. 63/769,815 filed Mar. 11, 2025. The entire disclosure of this application is incorporated herein by reference.

### BACKGROUND

Door locks are by far one of the most common security measures in both residential and commercial settings. The basic structure of locks has not changed in several hundred years. A user seeking to open a door inserts a key with an irregular, toothed shape into the lock. The teeth correspond to, and physically interact with, pins in the lock. If all of the pins are raised to the correct level by their corresponding key teeth, the user can disengage the locking mechanism. While this system has enjoyed widespread use, it does have limitations. Because only one configuration of teeth may open a given lock, if a key is lost, copied, or stolen, then the lock is no longer secure. Once that happens, the entire lock must be replaced or rekeyed, with new keys given to all users, a cumbersome and time consuming process. Because the lock is purely mechanical in nature, it does not create an entry record of who opened a door or when it was opened.

A physical lock face typically must be strong with a high hardness to endure malicious attacks. In some locks, this is achieved by adding small steel pieces to a brass lock face where it would be easy to drill and bypass. In other locks, the full face is made out of strong steel to be able to protect the entire face.

Electronic smart locks may lower the cost of rekeying cylinders and doors. Electronic locks with network connectivity may be remotely controlled. Lock access to individual users may be amended without need for physical access to the locks.

In regards to radio-frequency identification (RFID) locks, an electromagnetic signal is not able to pass through a plane of metal. As such, one common solution is to use a plastic face with the RFID reader with the locking mechanism attached on the inside of the door lock. If the plastic face is drilled through, the actual locking mechanism is not readily available. Some other locks use glass. One lock uses Gorilla Glass, a chemically strengthened glass developed by Corning. Glass is amorphous and progressively softens under heat.

Electronic smart locks must be small and hence need to work efficiently with both power and component size. A minimal number of components necessary to accomplish all these functions is needed. Traditional smart locks and access readers rely heavily on analog components for RFID signal processing, including level shifters, amplifiers, and various filters. These components contribute to higher costs, large circuit footprints, and limited flexibility in adapting to different access protocols.

Users have attempted to solve these problems through design decisions that accomplish these goals. However, locks remain large and unwieldy. There is an unmet need in the art of an electronic lock system that solves these problems. Proposed digital solutions address these limitations by using digital signal processing techniques to replace most analog components.

### SUMMARY

The embodiments presented within provide methods, devices, systems, and computer readable medium that improve access control through the use of locks. Some embodiments presented include mortise and key-in-knob form-factor locks.

In one aspect, a smart lock assembly is provided. The smart lock assembly comprises a solar cell layer configured to generate power for the smart lock assembly, a transparent cover positioned over the solar cell layer, and a circuit board operatively coupled to the solar cell layer and supporting electronic components of the smart lock assembly and the solar cell layer. The smart lock assembly further comprises a time-of-flight sensor operatively coupled to the circuit board and configured to emit an emitted signal and detect a return signal for user detection, and a cutout in a conductive layer of the solar cell layer aligned with the time-of-flight sensor, the cutout enabling transmission of a signal from the time-of-flight sensor without significant attenuation wherein the solar cell layer absorbs light while permitting the emitted signal and the return signal to pass through the cutout.

In some embodiments, the solar cell layer is sandwiched between the transparent cover and the circuit board.

In some embodiments, the transparent cover comprises sapphire glass.

In some embodiments, the transparent cover comprises a material with a high hardness that allows penetration of the emitted signal and the return signal.

In some embodiments, the time-of-flight sensor is a near-infrared proximity sensor.

In some embodiments, the cutout is created from the group consisting of a transparent conductive section of the solar cell layer, a reduced-thickness section of the solar cell layer, and a selective deposition section of the solar cell layer.

In some embodiments, the smart lock assembly further comprises a radio-frequency identification (RFID) processing module comprising an analog envelope detector that extracts a signal characteristic from an incoming radio-frequency identification (RFID) signal, a digital signal processor (DSP) configured to filter and to analyze the RFID signal, and an authentication module operatively coupled to the DSP, the authentication module verifying the RFID signal matches a credential.

In some embodiments, the DSP replaces analog amplifiers and filters for RFID signal processing.

In some embodiments, the authentication module is configured to adaptively adjust a parameter for filtering the RFID signal based on an environmental condition.

In some embodiments, the smart lock assembly further comprises a control board having a reflective coating to increase visibility and improve sensor accuracy, wherein the control board is operatively coupled to the circuit board.

In some embodiments, the reflective coating is an ultra-violet light curable coating.

In some embodiments, the reflective coating is selectively applied using a mask map to allow precise coverage while leaving optically sensitive components exposed.

In some embodiments, the reflective coating obscures chip markings to provide an additional layer of intellectual property protection.

In some embodiments, the reflective coating enhances a light-emitting diode brightness by reflecting light toward a display area.

In some embodiments, the smart lock assembly further comprises a mortise latch mechanism configured to automatically engage when a sliding door is closed.

In some embodiments, the mortise latch mechanism comprises a spring-loaded hook that engages with a receiving latch and a locking pin that prevents the spring-loaded hook from being disengaged when depressed.

In some embodiments, the locking pin operatively couples to a mortise cam, such that when the locking pin is depressed, the mortise cam rotates into a locking position, preventing the spring-loaded hook from retracting.

In some embodiments, the mortise latch mechanism is designed to be compatible with both half and full European lock cylinders.

In another aspect, a method of operating a smart lock assembly is provided. The method comprises generating power for the smart lock assembly via a solar cell layer, positioning a transparent cover over the solar cell layer, and operatively coupling a circuit board to the solar cell layer, the circuit board supporting electronic components of the smart lock assembly and the solar cell layer. The method further comprises operatively coupling a time-of-flight sensor to the circuit board, the time-of-flight sensor emitting an emitted signal and detecting a return signal for user detection, and aligning a cutout in a conductive layer of the solar cell layer with the time-of-flight sensor, the cutout enabling transmission of a signal from the time-of-flight sensor without significant attenuation wherein the solar cell layer absorbs light while permitting the emitted signal and the return signal to pass through the cutout.

In another aspect, a system for smart lock operation is provided. The system comprises a solar cell layer configured to generate power for the system, a transparent cover positioned over the solar cell layer, and a circuit board operatively coupled to the solar cell layer and supporting electronic components of the system and the solar cell layer. The system further comprises a time-of-flight sensor operatively coupled to the circuit board and configured to emit an emitted signal and detect a return signal for user detection, and a cutout in a conductive layer of the solar cell layer aligned with the time-of-flight sensor, the cutout enabling transmission of a signal from the time-of-flight sensor without significant attenuation wherein the solar cell layer absorbs light while permitting the emitted signal and the return signal to pass through the cutout.

### BRIEF DESCRIPTION OF THE DRAWINGS

FIG. 1 is an illustration of one embodiment of a receiver implemented both in analog and with a digital signal processing element.

FIG. 2 is an illustration of an embodiment of a receiver with three outputs.

FIG. 3 is an illustration of an embodiment of a filter.

FIG. 4 is an illustration of an embodiment of a smart lock with a solar cell front end.

FIG. 5 is an illustration of an embodiment of a solar cell assembly.

FIG. 6 is an illustration of side-view of one embodiment of a solar cell assembly, which forms the face of a smart lock.

FIG. 7 is an illustration of a control board in a smart lock system.

FIG. 8 is an illustration of the application process whereby a reflective coating is printed from printing head to control board.

FIG. 9 is an illustration of the curing process, where the deposited reflective coating is cured into a durable material.

FIG. 10 is an illustration of a mortise type smart lock.

FIG. 11 is an illustration of a mortise type smart lock with internal mechanism exposed.

FIG. 12 is an illustration of a mortise type smart lock with internal mechanism exposed where the hook is partially engaged.

FIG. 13 is an illustration of three views of a mortise type smart lock showing various positions of the components.

### DETAILED DESCRIPTION

Representative embodiments are described below with reference to the accompanying drawings. It should be understood that the following description is intended to describe representative embodiments, and not to limit the appended claims. In the present description, certain terms have been used for brevity, clarity, and understanding. No unnecessary limitations are to be applied there from beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112(f) only if the terms “means for” or “step for” are explicitly recited in the respective limitation.

A system and method is presented which reduces component count and improves flexibility in processing radio-frequency identification (RFID) signals for smart locks and access readers through digital signal processing (DSP) techniques. The system retains an analog envelope detector while integrating a microcontroller-based digital processing chain, reduces the count of traditional analog components such as amplifiers and filters. An anti-aliasing filter prepares the signal for digital conversion. The signal is converted in an analog-to-digital converter (ADC). Once converted, digital filters and other signal processing algorithms are implemented in a microcontroller. This leads to reduced manufacturing costs, enhanced design adaptability, and improved signal analysis capabilities in smart security devices. Further, the embodiments presented integrate digital processing, solar-powered authentication techniques, reflective coatings, and tamper resistant mechanisms to enable a more compact, efficient, secure, and cost-effective smart lock system not previously achievable in existing solutions. Commercial applications include, for example, hotels, short term rentals, consumer residential, business offices, show rooms, warehouses, industrial facilities, and secure facilities.

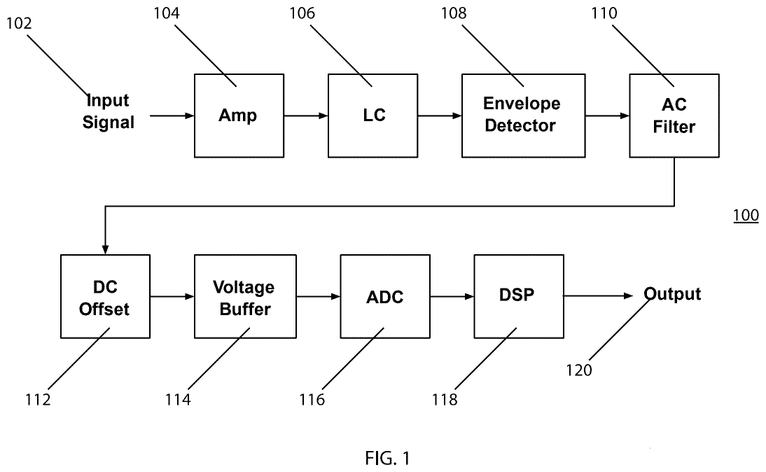

FIG. 1 is an illustration of one embodiment of a receiver 100 implemented with a digital signal processing element. An input signal 102 passes through an amplifier 104 into an inductor-capacitor (LC) filter 106. The LC filter acts as an anti-aliasing filter. The signal then passes through an envelope detector 108. The envelope detector may be implemented as a simple diode and resistor-capacitor (RC) circuit. The signal passes into an analog current (AC) filter 110. A direct current (DC) offset 112 shifts the voltage of the signal. Finally a voltage buffer 114 buffers the signal before being sent to analog-to-digital converter (ADC) 116.

Analog-to-digital converter (ADC) 116 converts the filtered analog signal after the voltage buffer 114 into a digital signal. The digital signal is processed by the DSP 118. Processing can include implementing band-pass and low-pass filters using digital algorithms. A microcontroller can perform the digital signal processing algorithms. The DSP can include real-time parameter tuning to improve signal processing. Ultimately, the microcontroller may authenticate credentials from the signal allowing the smart lock or access reader to operate.

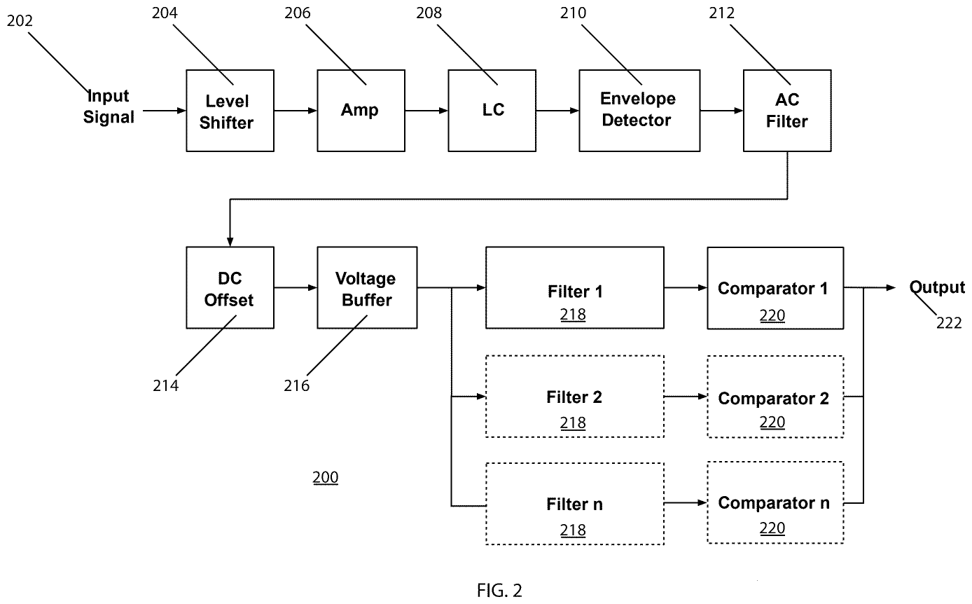

FIG. 2 is an illustration of an embodiment of an alternative receiver 200 with three outputs. In this embodiment, the input signal 202 passes through level shifter 204 first. The signal then is sent through amplifier 206 and LC filter 208. The signal passes through envelope detector 210 and AC filter 212 followed by DC offset 214. A voltage buffer 216 buffers the signal so it can be passed through multiple filter-comparator stages. Each filter 218 is tuned for comparator 220 before being passed as output 222. Output 222 may be a wired-or composite of multiple pulse width modulated output stages.

Similarly to the preceding description, after envelope detector 210, an ADC can convert the signal to digital form. A microcontroller can implement the following components through digital signal processing. AC filter 212 and DC offset, level shifting, can be implemented digitally. This transition results in a significant reduction of components and simplifies the overall design of the smart locking mechanisms and access readers.

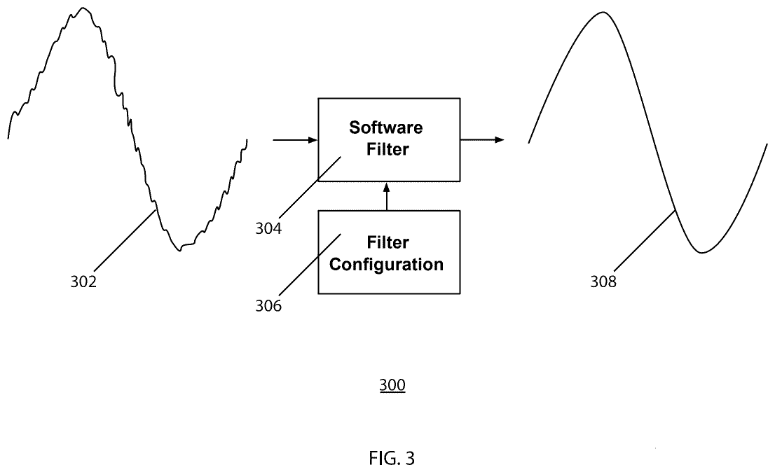

FIG. 3 is an illustration of an embodiment of a filter 300. The illustration shows input signal 302 passing through software filter 304. Software filter 304 is tuned with filter configuration 306. Software filter 304 produces the cleaned signal 308 which is available for further processing. Filter configuration 306 may be dynamically tuned in real-time to produce a cleaner output signal 308.

Overall, the system as described has a significant component reduction and simplifies PCB layout resulting in lower component and manufacturing costs. In addition, because the filter characteristics may be determined dynamically, real-time tuning and adaptation to various RFID protocols are possible without hardware modifications. The system can be designed to be compatible with a diverse set of access control systems while increasing reliability because there are fewer components that can fail.

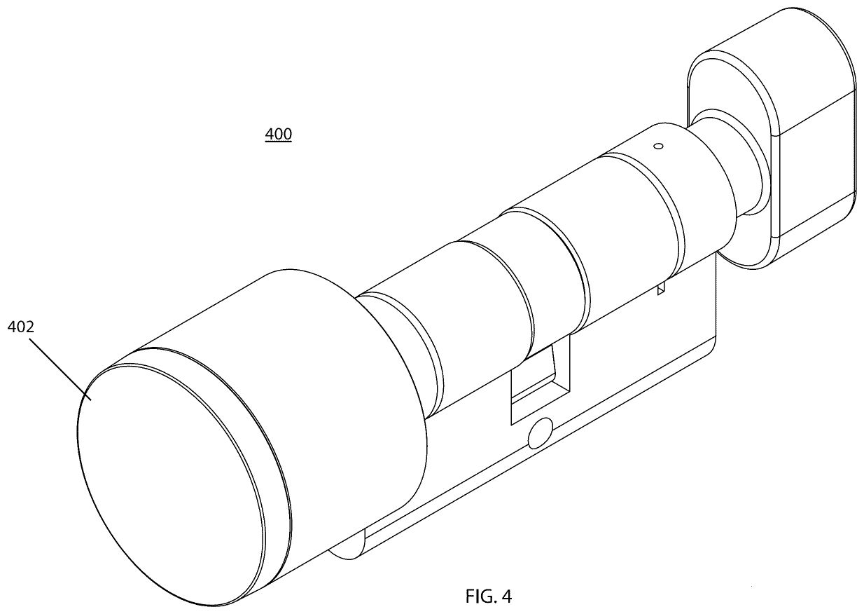

FIG. 4 is an illustration of an embodiment of a smart lock 400 with a solar cell 402 front end. A solar cell 402 may be integrated into a smart lock 400 to generate power that can be used to power the lock. The solar cell may be used either as a primary or supplemental power source. However, there are design challenges in maximizing power output from the solar cell while integrating all necessary components for the smart lock. One possible component necessary is a time-of-flight (ToF) sensor. A ToF sensor may be used for user detection, presence sensing, authentication, or other functions. Other types of necessary components may include cameras, sensors, indicators, transmitters, receivers, or various other electromagnetic devices.

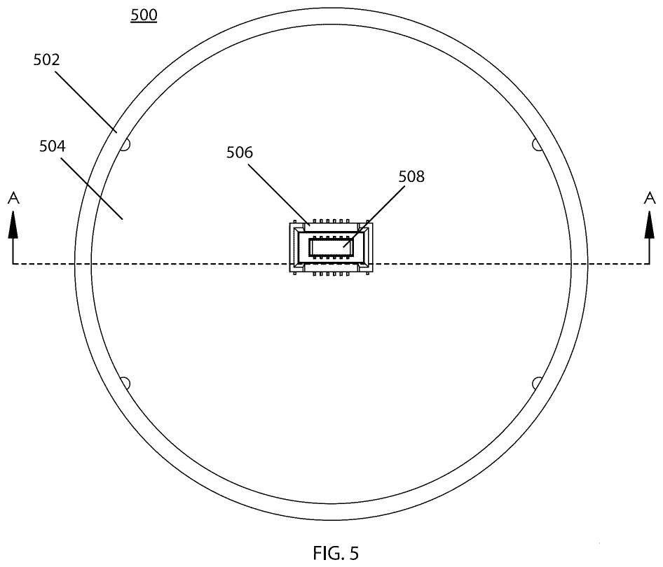

FIG. 5 is an illustration of an embodiment of a solar cell assembly 500. The solar cell assembly 500 has sapphire glass 502 with circuit board 504. Solar cell material is sandwiched between sapphire glass 502 and circuit board 504. Connector 506 and ToF sensor 508 are integrated into circuit board 504. The ToF sensor 508 could be any one of a number of different near-infrared (NIR) proximity sensors. The solar cell material may comprise perovskite-based cells, silicon-based, thin-film, or other suitable materials. In conventional designs, the time-of-flight sensor cannot detect signals through continuous solar cell material without resorting to aesthetically disruptive perforations. Therefore, an alternative approach is necessary.

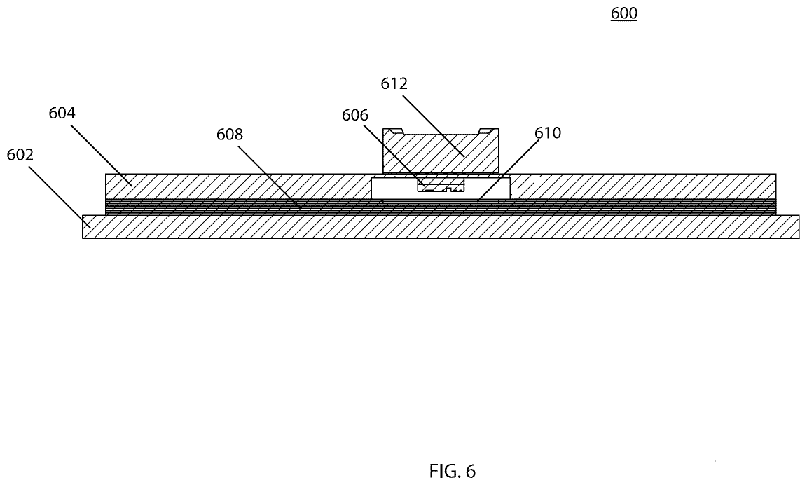

FIG. 6 is an illustration of a side-view of one embodiment of a solar cell assembly 600, which forms the face of a smart lock. Transparent cover 602 covers the outside of the solar cell assembly 600. Transparent cover 602 may be made of sapphire glass or any other material that both offers physical protection and allows required electromagnetic wavelengths to penetrate sufficiently. Circuit board 604 forms the substrate for subsequent components and may be made of FR4 circuit board material or any other material used for circuit boards, common or uncommon. Circuit board 604 has a cutout in part of its thickness where ToF sensor 606 has been mounted to look out through transparent cover 602. Sandwiched between transparent cover 602 and circuit board 604 is solar cell material 608. A cutout 610 in the conductive base of solar cell material 608, in some embodiments this is a carbon layer, allows signals from ToF sensor to pass through the solar cell material 608 to the transparent cover 602 and back. Alternative structures that enable transmission are possible, such as a transparent conductive section, a reduced-thickness layer, selective deposition techniques, or other approaches to create areas where transmission is possible. The approach may be modified to include any layer needing more transmission of signals than may otherwise penetrate, while leaving alone layers that have less effect on the overall signal transmission. Connector 612 interfaces the solar cell assembly 600 to the rest of the smart lock.

One example of a solar cell material is a perovskite solar cell. A perovskite solar cell comprises multiple layers, including a top transparent conductive layer such as indium tin oxide (ITO) or fluorine-doped tin oxide (FTO). Another layer comprises the perovskite organic solar compound. Perovskite absorbs visible light but may be translucent in ultraviolet (UV) or infrared (IR) wavelengths. Another layer includes a bottom conductive layer such as antimony-doped tin oxide (ATO) or carbon. Another layer includes an encapsulating substrate, which may comprise glass, sapphire glass, flexible polymers, durable resins, or other substrate where whichever substrate chosen is translucent in whichever wavelengths sensors or emitters are using. Many other options are possible in all of these layers. In one embodiment, an opening can be created in any of the non-transmissive layers, such as the carbon layer. In this instance, electromagnetic transmissions can penetrate the solar cell layer. For example, an NIR sensor's laser can pass through without disrupting the solar cell's visible light absorption. This technique can be used to prevent any layer's blocking effects from stopping signal communication. Additionally, the solar cell's absorption of visible light means there is no visual discontinuity from a user's perspective. This approach preserves device's aesthetics and power efficiency while minimizing loss of solar energy harvesting compared to traditional hole-drilling methods.

There are several challenges associated with traditional white solder masks and silkscreen printing on printed circuit boards (PCB). Unprinted areas absorb light that would be better reflected for both improved visibility and improved detection characteristics. When solder masks, silkscreen printing, or paint are applied, the change increases the thickness of the PCB and can lead to solder shorts under sensitive ball grid array (BGA) components and other fine pitched components. Solder masks and printing can inadvertently lift solder stencils above their pads, leading to the risk of bridging or opens during reflow. Additionally alignment errors in solder masks and printing can lead to areas where solder doesn't adhere to the PCB. Solder masks and printing may have different thicknesses, based on color or type of ink, and this varying thickness can have detrimental effects on the overall design. Wafer-level chip-scale packages (WLCSP) must be shielded from light exposure. Light emitting and detecting devices as well as interface devices must be shielded from painting. Selective post-assembly printing can enhance reflectivity and brightness of LEDs, provide protection for WLCSP components, and offer an additional layer of intellectual property (IP) protection by obscuring chip markings. A targeted, post-assembly solution is needed that can address these issues, enhancing reflectivity while protecting light-sensitive packages and remaining cost effective.

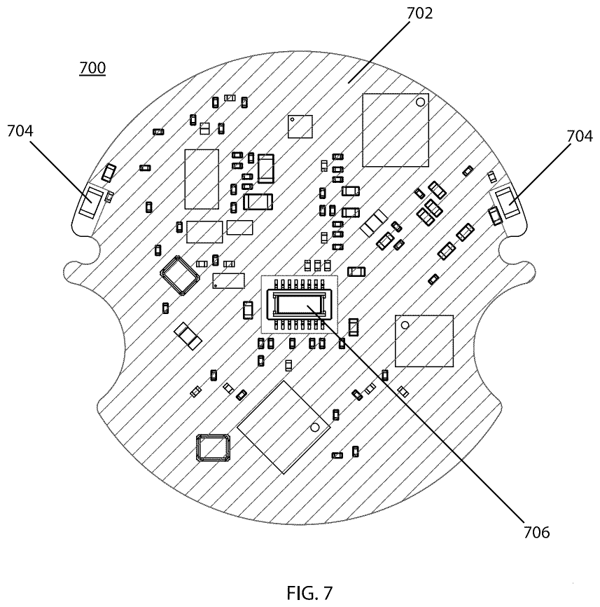

FIG. 7 is an illustration of a control board 700 in a smart lock system. The control board 700 is covered in a reflective coating 702. The reflective coating 702 may be a white, UV-curable ink. Reflective coating 702 includes cutouts around optical components such as photodiode 704 and connectors such as connector 706. A UV-ink printer enables precise application, covering only those components that need it while leaving photodiodes and connectors exposed. A white, UV-curable ink significantly boosts brightness and enhances light reflected in the area.

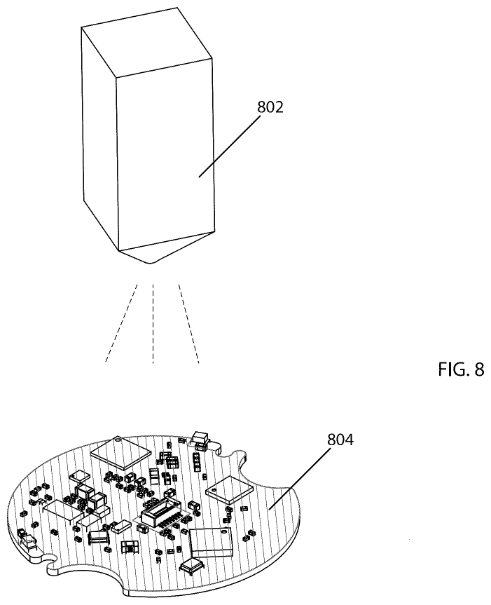

FIG. 8 is an illustration of the application process whereby a reflective coating is printed from printing head 802 to control board 804. UV-capable inkjet or screen printers can be configured with high-contrast, white UV-curable ink. The printer is programmed with a selective ‘mask map’ that defines the precise areas of the assembled PCB to be coated. Printing head 802 prints the coating over areas of the board which are not optically active, avoiding areas such as LEDs or sensors that need to emit or detect light. The mask map enables targeted coverage over desirable areas such as the perimeter of LEDs for reflectivity, over WLCSPs for light blocking, and over large black chips to enhance reflectivity or obscure markings.

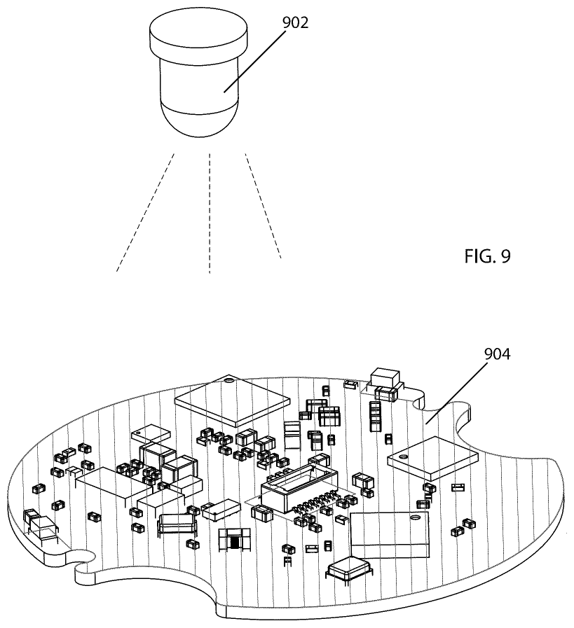

FIG. 9 is an illustration of the curing process, where the deposited reflective coating is cured into a durable material. An ultraviolet light source 902 is projected onto the reflective coating previously deposited on the control board 904. The cured layer forms a durable, opaque, and reflective surface resistant to wear and environmental factors. While white UV inks work well, other colors or specialized inks may be used if future product designs require varying aesthetics or different optical properties, such as filtering and emission. The optical coating can be inspected visually or via automated optical inspection (AOI) to verify precise ink placement and ensure adequate coverage thickness.

After coating and curing, the PCB can be integrated into the smart lock assembly. The reflective coating around LED-based light rings ensures superior brightness of the display. The covered WLCSPs are protected from ambient light interference.

Current sliding door locks lack integrated, automatic self-locking mechanisms compatible with European cylinders and other types of lock cylinders too. Traditional clutch-based smart locks are incapable of actively securing sliding doors due to power constraints and mechanical limitations. A mortise latch is presented that automatically engages when a sliding door closes. A spring-loaded hook and locking pin ensure high security locking without manual intervention.

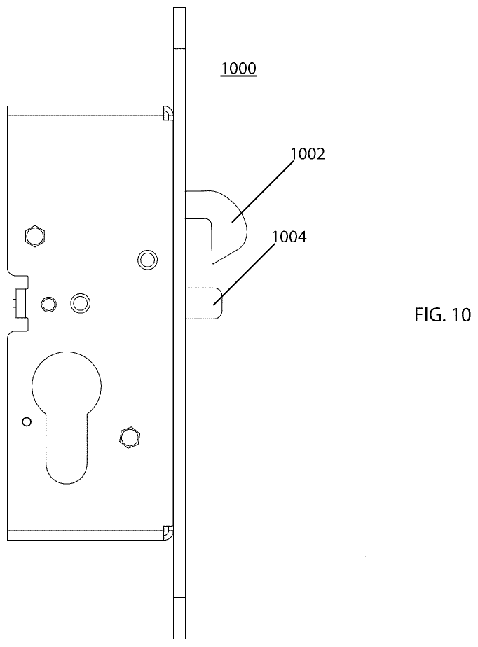

FIG. 10 is an illustration of a mortise type smart lock 1000. The mortise type smart lock 1000, also called a latch, may be compatible with mechanical or other smart lock cylinders, includes hook 1002 and pin 1004. To add tamper resistance, depressing pin 1004 locks hook 1002, preventing it from opening.

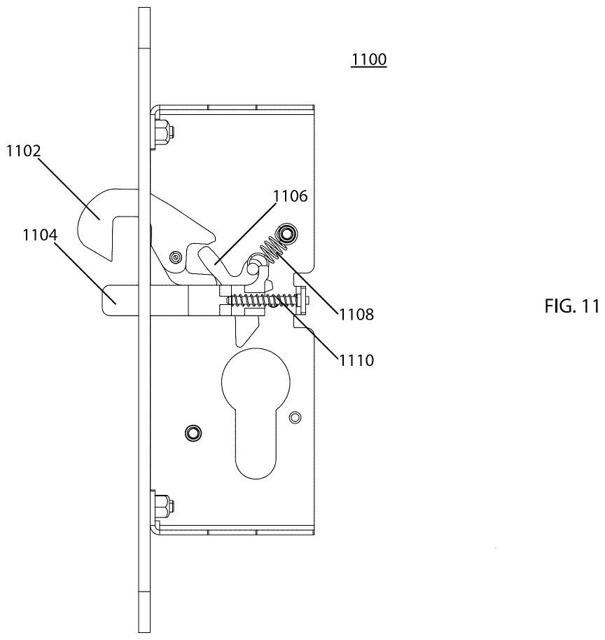

FIG. 11 is an illustration of a mortise type smart lock 1100 with internal mechanism exposed. Hook 1102 engages with a receiving latch on a door frame while in locked position. Pin 1104 prevents hook 1102 from moving when it is depressed, such as when it is engaged in the receiving door frame. Mortise cam 1106 operates hook 1102 when rotated by a lock cylinder. Mortise cam spring 1108 returns mortise cam 1106 to a position that allows hook 1102 to move freely. When pin 1104 is pressed in or pushed back into the mortise type smart lock 1100, pin 1104 causes mortise cam 1106 to be in a locked state. When pin 1104 is pressed in or pushed back, mortise cam spring 1108 may pull mortise cam 1106 back slightly, in one embodiment it turns about five degrees further, which leaves pin 1104 and mortise cam 1106 in a locking position where mortise cam 1106 now interferes with the rotation of hook 1102. In the embodiment, pin spring 1110 may impart more force on mortise cam 1106 than mortise cam spring 1108. When pin 1104 is not pressed in, pin spring 1110 pushes pin 1104 out, releasing the mortise cam 1106. With pin 1104 not pressed in, mortise cam spring 1108 returns mortise cam 1106 to its neutral state.

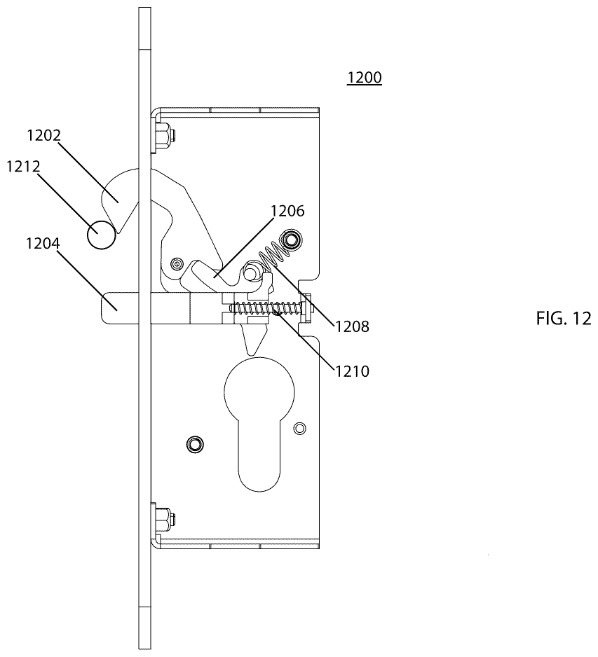

FIG. 12 is an illustration of a mortise type smart lock 1200 with internal mechanism exposed, showing the hook in a partially engaged position. The illustration includes hook 1202, pin 1204, mortise cam 1206, mortise cam spring 1208, and pin spring 1210. Additionally, receiving hook 1212 is depicted. Receiving hook 1212 is part of the door frame, not pictured.

Mortise cam 1206 is partially rotated, demonstrating its engagement with hook 1202. In this instance, the relative movement of receiving hook 1212, as the door closes, drives the rotation of hook 1202. As the door moves, receiving hook 1212 passes the tip of the hook 1202, at which point mortise cam spring 1208 and mortise cam 1206 snap hook 1202 down over the receiving hook 1212, securing the lock.

Mortise cam 1206 may also be rotated via a portion of mortise cam 1206 at its bottom that interfaces with a lock cylinder cam, allowing it to be operated by a smart lock cylinder or other type of lock cylinder. When pin 1204 is fully depressed, mortise cam 1206 may only be rotated by a lock cylinder cam. When it is operated by a lock cylinder, mortise cam 1206 can rotate hook 1202 back up over receiving hook 1212 to disengage the lock and to allow the door to be opened.

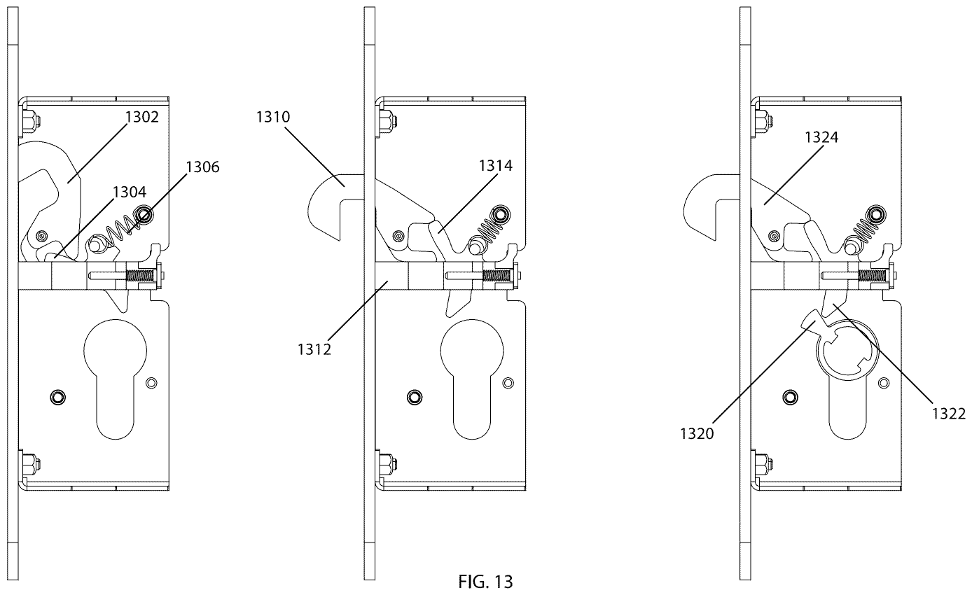

FIG. 13 is an illustration of three views of a mortise type smart lock showing various positions of the components. First, hook 1302 is shown fully retracted. In this orientation, mortise cam 1304 is pressed against one part of hook 1302. Mortise cam spring 1306 pulls up on mortise cam 1304 which in turn pushes hook 1302 down, to engage in an unshown pin and to lock the door. In the next view, hook 1310 is in a horizontal locked position. Pin 1312 is fully depressed which clears mortise cam 1314 to retract completely. Fully retracted, mortise cam 1314 engages with the flat portion of hook 1310 which prevents hook 1310 from being lifted by any external forces. In fact, the only way to raise a hook in this configuration is shown in the last view. Lock cylinder cam 1320 is the operative component of a lock cylinder. Lock cylinder cam 1320 engages with mortise cam 1322. The mortise cam 1322 rotates, releasing hook 1324. As it continues to rotate, mortise cam 1322 can then push hook 1324 up, unlocking the whole lock.

The lock shown fits both half and full European lock cylinders making it compatible with many different traditional locks and smart locks. The pin and hook system resists tampering including shimming and forced entry. The locking mechanism may include a pin/hook system or other mechanical engagement such as a sliding bolt, rotary latch, or magnetic lock. The latch can be made of corrosion resistant and durable materials for overall reliability.

All publications and patent applications mentioned in this specification are herein incorporated by reference to the same extent as if each individual publication or patent application was specifically and individually incorporated by reference.

The foregoing description of representative embodiments has been presented for purposes of illustration and description. It is not intended to be exhaustive or to limit the claims to the precise form disclosed, and modifications and variations are possible in light of the above teachings or may be acquired from practice. The embodiments were chosen and described in order to explain the principles of the claims and its practical embodiments to enable one skilled in the art to utilize the claims in various embodiments and with various modifications as are suited to the particular use contemplated.

It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying the principles of the invention. Similarly, it should be appreciated that any flow charts, flow diagrams, signal diagrams, system diagrams, codes, and the like represent various processes which may be substantially represented in computer-readable medium and so executed by a computer or processor, whether or not such computer or processor is explicitly shown. In addition, one or more flow diagrams were used herein. The use of flow diagrams is not intended to be limiting with respect to the order in which operations are performed.

The functions of the various elements shown in the drawings, including functional blocks labeled as “processors,” “digital signal processors,” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “microcontroller,” “processor,” or “controller” should not be construed to refer exclusively to hardware capable of executing software, and may implicitly include, without limitation, digital signal processor (DSP) hardware, read-only memory (ROM) for storing software, random access memory (RAM), non-volatile storage, or amalgamations of digital or analog logic. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function or software in any form, including, therefore, firmware, micro-code or the like, combined with appropriate circuitry for executing that software to perform the function. The invention as defined herein resides in the fact that the functionalities provided by the various recited means are combined and brought together in the manner which the operational descriptions call for. Applicant regards any means which can provide those functionalities as equivalent as those shown herein.

1. A smart lock assembly comprising:
a solar cell layer configured to generate power for the smart lock assembly;
a transparent cover positioned over the solar cell layer;
a circuit board operatively coupled to the solar cell layer and supporting electronic components of the smart lock assembly and the solar cell layer;
a time-of-flight sensor operatively coupled to the circuit board and configured to emit an emitted signal and detect a return signal for user detection; and
a cutout in a conductive layer of the solar cell layer aligned with the time-of-flight sensor, the cutout enabling transmission of a signal from the time-of-flight sensor without significant attenuation wherein the solar cell layer absorbs light while permitting the emitted signal and the return signal to pass through the cutout.

2. The smart lock assembly of claim 1, wherein the solar cell layer is sandwiched between the transparent cover and the circuit board.

3. The smart lock assembly of claim 1, wherein the transparent cover comprises sapphire glass.

4. The smart lock assembly of claim 1, wherein the transparent cover comprises a material with a high hardness that allows penetration of the emitted signal and the return signal.

5. The smart lock assembly of claim 1, wherein the time-of-flight sensor is a near-infrared proximity sensor.

6. The smart lock assembly of claim 1, wherein the cutout is created from the group consisting of a transparent conductive section of the solar cell layer, a reduced-thickness section of the solar cell layer, and a selective deposition section of the solar cell layer.

7. The smart lock assembly of claim 1, further comprising a radio-frequency identification (RFID) processing module comprising an analog envelope detector that extracts a signal characteristic from an incoming radio-frequency identification (RFID) signal, a digital signal processor (DSP) configured to filter and to analyze the RFID signal, and an authentication module operatively coupled to the DSP, the authentication module verifying the RFID signal matches a credential.

8. The smart lock assembly of claim 7, wherein the DSP replaces analog amplifiers and filters for RFID signal processing.

9. The smart lock assembly of claim 7, wherein the authentication module is configured to adaptively adjust a parameter for filtering the RFID signal based on an environmental condition.

10. The smart lock assembly of claim 1, further comprising a control board having a reflective coating to increase visibility and improve sensor accuracy, wherein the control board is operatively coupled to the circuit board.

11. The smart lock assembly of claim 10, wherein the reflective coating is an ultra-violet light curable coating.

12. The smart lock assembly of claim 10, wherein the reflective coating is selectively applied using a mask map to allow precise coverage while leaving optically sensitive components exposed.

13. The smart lock assembly of claim 10, wherein the reflective coating obscures chip markings to provide an additional layer of intellectual property protection.

14. The smart lock assembly of claim 10, wherein the reflective coating enhances a light-emitting diode brightness by reflecting light toward a display area.

15. The smart lock assembly of claim 1, further comprising a mortise latch mechanism configured to automatically engage when a sliding door is closed.

16. The smart lock assembly of claim 15, wherein the mortise latch mechanism comprises a spring-loaded hook that engages with a receiving latch and a locking pin that prevents the spring-loaded hook from being disengaged when depressed.

17. The smart lock assembly of claim 16, wherein the locking pin operatively couples to a mortise cam, such that when the locking pin is depressed, the mortise cam rotates into a locking position, preventing the spring-loaded hook from retracting.

18. The smart lock assembly of claim 15, wherein the mortise latch mechanism is designed to be compatible with both half and full European lock cylinders.

19. A method of operating a smart lock assembly comprising:
generating power for the smart lock assembly via a solar cell layer;
positioning a transparent cover over the solar cell layer;
operatively coupling a circuit board to the solar cell layer, the circuit board supporting electronic components of the smart lock assembly and the solar cell layer;
operatively coupling a time-of-flight sensor to the circuit board, the time-of-flight sensor emitting an emitted signal and detecting a return signal for user detection; and
aligning a cutout in a conductive layer of the solar cell layer with the time-of-flight sensor, the cutout enabling transmission of a signal from the time-of-flight sensor without significant attenuation wherein the solar cell layer absorbs light while permitting the emitted signal and the return signal to pass through the cutout.

20. A system for smart lock operation comprising:
a solar cell layer configured to generate power for the system;
a transparent cover positioned over the solar cell layer;
a circuit board operatively coupled to the solar cell layer and supporting electronic components of the system and the solar cell layer;
a time-of-flight sensor operatively coupled to the circuit board and configured to emit an emitted signal and detect a return signal for user detection; and
a cutout in a conductive layer of the solar cell layer aligned with the time-of-flight sensor, the cutout enabling transmission of a signal from the time-of-flight sensor without significant attenuation wherein the solar cell layer absorbs light while permitting the emitted signal and the return signal to pass through the cutout.
